(19) United States
(12) Patent Application Publication
(10) Pub. No.: US 2011/0102739 A1
(43) Pub. Date: May 5, 2011

(54) METHODS AND MACHINES FOR LENS DEBLOCKING

(76) Inventors: Pascal . Lefort, Saint Ouen L'aumone (FR); Alain H. Lamon, Angers (FR)

(21) Appl. No.: 12/867,385

(22) PCT Filed: Feb. 13, 2009
(86) PCT No.: PCT/US09/33982

§ 371 Date: Dec. 7, 2010

(30) Foreign Application Priority Data
Feb. 14, 2008 (GB) 0802651.0

(51) Int. Cl. G02C 7/02; B23P 19/00

(52) U.S. Cl. 351/177; 29/791

(57) ABSTRACT

The present invention relates to a method of deblocking (e.g. de-attaching) a non-metal-alloy lens block on a processed lens, wherein the lens block has a first end facing towards the processed lens. The method comprises cutting the lens block through its diameter near the first end. A lens block is used to hold a lens in place during processing, and in some applications is used in the manufacture of ophthalmic lenses.

The present invention relates generally to methods for use in deblocking (e.g. de-attaching) a lens block, in particular deblocking a non-metal-alloy lens block, and methods of blocking and deblocking and processing lenses as well as machines therefor.

### BACKGROUND

Presently the most common method used to hold a lens in place during processing (e.g. machining, grinding, polishing and/or any other desired or necessary treatment so as to form a commercially usable lens) makes use of a low-melting-temperature metal alloy to form or attach a “block” to a major surface (i.e. the major surface opposite of the major surface to be processed) of a lens blank. This procedure is often referred to as “lens blocking” Lens blocks are generally cylindrical or truncated conical in form generally with one end (i.e. the end facing towards the lens blank), having a wider portion. Lens blocks used for ophthalmic lenses are generally about 35 to about 85 mm in diameter. A common low-melting-temperature metal alloy comprises bismuth, tin, lead, cadmium, indium, and antimony.

Prior to attaching the lens block onto the major surface of the lens blank, a tape may be first applied onto the surface, whereby the lens block is subsequently formed or attached onto the applied tape. The use of such a surface tape can help to prevent the lenses from being scratched by the metal alloy, serve as a heat shield (e.g., to protect a plastic lens from warping due the heat of the metal alloy), and/or facilitate better or enhance further metal alloy adherence. Tapes for this purpose are commercially available (e.g. under the trade designation 3M Surface Saver from 3M Company) and may be applied by placing the lens in a small chamber, stretching the tape over the chamber, and applying a partial vacuum.

After the desired processing of the exposed surface of the lens, the metal alloy lens block is typically deblocked through shock deblocking (i.e. striking the lens to-be-deblocked with a ring or hammer) or hot-water deblocking. The former is the most commonly used method of deblocking. In shock deblocking, the metal alloy lens block drops off the lens due to the mechanical shock. In hot-water deblocking, lenses-to-be-deblocked are immersed in a tank with hot water so that the metal alloy melts and thus flows off the lenses. The liquid metal alloy drips to the bottom of the tank and there is a valve at the bottom of the tank through which the liquid metal alloy can be recovered and recycled (i.e. used again for forming lens blocks).

After deblocking, if applicable the surface tape is removed and the lens is cleaned.

Unfortunately, many of the present metal alloy materials used as lens blocks pose significant environmental and health hazards.

Lens blocking compositions that are not metal alloys are known. In the following such compositions will be generally referred to as non-metal-alloy blocking compositions, and lens blocks made therefrom as non-metal-alloy lens blocks. Non-metal-alloy lens blocking compositions include for example compositions based on waxes or curable/cured thermoset materials or thermoplastic materials.

For example, U.S. Pat. No. 7,101,920 (Bonfini et al), discussing that the conventional ways of removing wax-based lens blocks from the lens blanks after processing the exposed surface thereof include mechanically prying the lens block from the processed lens blank or heating so that the blocking wax melts away, discloses a water-soluble wax formulation for use as a lens block and that the lens block can be removed from the lens after machining by rinsing with warm water.

WO 94/08788 (Salamon and Demarco), for example, discloses the use of a radiation curable adhesive composition as a lens block, wherein during attachment of the lens blank and lens block, the assembly is exposed to an initial irradiation to fix the lens blank to the lens block to assure proper alignment, and thereafter, the assembly is again exposed to radiation for a further period of time to fully cure the adhesive. It is disclosed that following working of the exposed surface of the lens blank, the lens assembly then is placed in an appropriate debonding solution, for example water and detergent, acetone, and the like, for a sufficient period of time to debond the lens piece from the lens block. It is disclosed that deblocking times may be as much as one hour or more, but it is preferred, however, to maintain a deblocking time of less than about forty minutes, preferably less than about thirty minutes, and that in order to accelerate deblocking, it is preferred that the temperature of the solution, especially with respect to the aqueous based solutions, be maintained at temperatures from room temperature up to, preferably, about 80° C.

As another example, EP 851 800 (Benjamin et al) discloses lens blocks comprising a solidified mass of thermoplastic blocking composition, the composition being solid at 21° C. and having a sufficiently low melting or softening point such that the composition may be placed adjacent to an ophthalmic lens blank while at its melting or softening point without damaging the lens blank. It is disclosed that the thermoplastic blocking composition may comprise a thermoplastic material selected from the group consisting of polyesters, polyurethanes, ionomer resins of ethylene copolymers, polyester-polysiloxane block copolymers, segmented copolyesters and polyetheresters, ethylene vinyl acetate resins and copolymers, polycaprolactones and blends of polycaprolactones. It is disclosed that lenses may be deblocked for example by melting the blocking composition in hot water or, if an appropriate balance of adhesion can be achieved (e.g. providing blocking compositions that adhere to the lens blank with a sufficient strength to avoid unintended detachment of the lens during processing, yet allow deblocking of the lens using traditional shock deblocking), by shock deblocking. It is disclosed that the level of adhesion of blocking compositions comprising polycaprolactone polymers is often too high and causes difficulties when user attempts to deblock the lens and block.

### SUMMARY OF INVENTION

Although non-metal-alloy blocking compositions are known and/or have been suggested, presently their industrial use in processing lenses is quite limited even though there is a strong and long-time desire to replace metal alloy lens blocks due to inter alia toxicity and environmental issues. A part of the issue seems to be that the method of deblocking of metal alloy lens blocks by shock is in practice generally not applicable for non-metal-alloy lens blocks. Moreover non-metal-alloy lens block compositions typically have properties (e.g. adhesive properties) which do not allow for deblocking using traditional shock deblocking. Other methods of deblocking of non-metal-alloy lens blocks that have been used or suggested are generally time-consuming, often messy, and/or do not lend themselves for use in in-line production facilities for processing of lenses. Also for non-metal-alloy lens blocking compositions that could be recycled, such other deblocking methods (e.g. melting in hot water) often preclude a possibility of recycling of the blocking composition.

It has been found that a time-effective and clean method of deblocking non-metal-alloy lens block can be achieved by cutting the lens block through its diameter near (e.g. close but at a distance to) the end of the lens block facing towards the lens. The method is also suitable and convenient for use in in-line production facilities for processing lenses, in particular ophthalmic lenses. Also for recyclable non-metal-alloy lens blocking compositions, it allows for a clean and easy recovery of a substantial portion of the blocking composition which can then be re-used for forming lens blocks.

Accordingly according to one aspect of the present invention there is provided a method of deblocking a non-metal-alloy lens block, said lens block having a first end facing towards the processed lens, said method comprising cutting the lens block through its diameter near said first end.

According to a second aspect of the present invention there is provided a method of blocking and deblocking a lens, said method comprising the steps: providing a lens blank; forming or attaching a non-metal-alloy lens block onto the lens blank, such that a first end of the lens block faces towards a major surface of the lens blank, said major surface of the lens blank being opposite to the surface of the lens blank to be processed; and cutting the lens block through its diameter near said first end. Another aspect of the present invention is a method of processing a lens, said method comprising in addition to the aforesaid steps of blocking and deblocking a step of processing the exposed surface of the lens blank, said step being performed at least subsequent to the step of forming or attaching a lens block and at least prior to the step of cutting the lens block.

After cutting, residual amount of lens block composition remaining can be removed, e.g. mechanically or by melting or by cleaning with water or by cleaning with/immersion in an appropriate solution, depending on the particular lens block composition.

However it has been found particularly advantageous to use a tape between the lens block and lens blank so that after cutting the lens block as described herein the tape can be removed and therewith the residual amount of lens block composition remaining after cutting. So for such advantageous methods of deblocking, a tape is located between the first end of the lens block and the major surface of the processed lens facing towards the lens block and the method further comprises an operation of removing the tape and thereby removing residual amount of lens block composition remaining after cutting. For such advantageous methods of blocking and deblocking and methods of processing a lens, desirably said methods further comprise a step of applying a tape over the major surface of the lens blank prior to forming or attaching the lens block and a step of removing the tape subsequent to cutting the lens block, and wherein in the step of forming or attaching the lens block, the lens block is formed or attached onto the applied tape.

Cutting the lens block as described herein is also desirable in that it allows one to avoid risks of damaging or breaking the processed lens associated with deblocking methods where the lens block is mechanically pried off the processed lens. To further minimize potential damage to the processed lens while cutting the lens block near its first end, desirably the lens block is cut via a method allowing for a fine and/or precision cut through the lens block. In particular it is desirable that the lens block is cut via hot-cutting (in particular cutting by hot-wire or hot-blade), ultrasonic cutting, laser cutting, or water-jet cutting. These methods are also advantageous in that they generally facilitate rapid cutting and thus rapid deblocking.

An additional aspect of the present invention is the provision of a machine for deblocking a non-metal-alloy lens block on a processed lens, said lens block having a first end facing towards the processed lens, the machine comprising at least one cutter and the machine being adapted and configured for cutting the lens block through its diameter near said first end. In preferred embodiments of such a machine for deblocking, wherein a tape is located between the first end of the lens block and the major surface of the processed lens facing towards the lens block, the machine is further adapted and configured for removing the tape thereby removing residual amount of lens block composition remaining after cutting. A further aspect of the present invention is the provision of a machine for processing a lens, the machine comprising a production line defined by a series of operating stations, the production line comprising a lens blocking station for forming or attaching a non-metal-alloy lens block onto the lens blank, such that a first end of the lens block faces towards a major surface of the lens blank, said major surface being opposite to the surface of the lens blank to be processed; one or more processing stations for processing the exposed surface of the lens blank; and a deblocking station comprising at least one cutter for cutting the lens block through its diameter near said first end. In preferred embodiments of such a machine, the production line further comprises upstream to the lens blocking station a tape application station for applying a tape to the major surface of the lens blank, either production line or the deblocking station further comprises a tape removing station or sub-station, respectively, for removing the tape from the processed lens after cutting of the lens block, and the lens blocking station is adapted and configured for forming or attaching the lens block onto the tape applied to the major surface of the lens blank in the tape application station. Desirably the at least one cutter is a hot cutter (more particularly a hot wire cutter or a hot blade cutter), a laser cutter, an ultrasonic cutter or a water jet cutter.

### BRIEF DESCRIPTION OF THE DRAWINGS

FIG. 1 is a schematic, side, cross-sectional view of an exemplary lens-lens block assembly.

FIG. 2 is a schematic, side, cross-sectional view of the resulting portions of the exemplary assembly shown in FIG. 1 after cutting the lens block in accordance to a method described herein.

### DETAILED DESCRIPTION

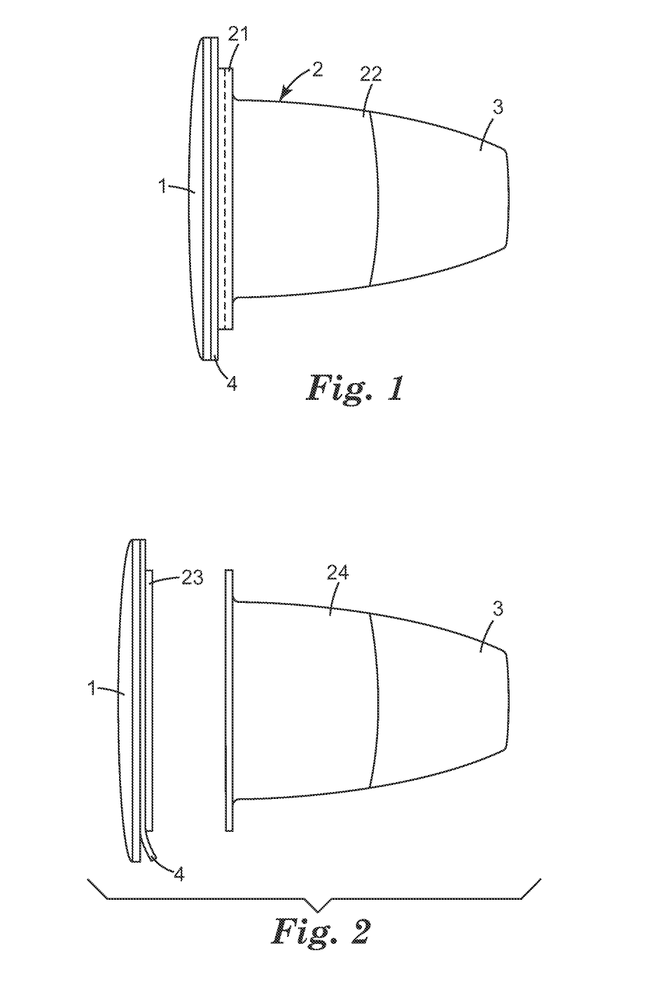

In order to better understand the present invention, reference is made to FIG. 1 showing a schematic, side, cross-sectional view of an exemplary lens-lens block assembly. The illustrated exemplary assembly includes a processed lens (1), i.e. a lens that has already being processed (e.g. machined, ground, polished, etc.). Prior to processing, the un-processed lens is typically described as a lens blank. The assembly also includes a non-metal-alloy lens block (2). (In the following unless specified otherwise, the term “lens block” is to be understood as a non-metal alloy lens block and accordingly the term “block composition” as a non-metal-alloy blocking composition.) The lens block (2) has a first end (21) facing towards the processed lens (1), and of course prior to processing, towards the lens blank. As shown in the exemplary assembly, the second end (22) of the lens block (2) may face and be attached to a base block (3) that is sized and adapted to fit the chuck of a desired lens processing machine or, if applicable, desired lens processing machines. Such a base block, if used, is typically made of a plastic or a metal, such as aluminum or stainless steel. Although base blocks are presently commonly used (e.g. commonly used with metal alloy lens block to reduce the amount the metal alloy used), it will be appreciated that its use is optional and that the lens block itself may be configured (e.g. extended) to provide a rear portion that is sized and adapted to the chuck of the desired lens processing machine(s). As can be appreciated from the illustration the lens block (2) is generally cylindrical or truncated conical in form having a wider portion near the lens/lens blank. For ophthalmic lenses, the lens block can have a diameter in the range from about 35 to about 85 mm. The length of the lens block may be in the range from about 10 to about 50 mm, when a base block is used, and when no base block is used, in the range from about 30 to about 90 mm.

Blocking is typically achieved by providing a lens blank and forming or attaching a lens block onto the lens blank, such that a first end of the lens block faces towards a major surface of the lens blank. In particular the lens block may be formed or attached directly onto the lens blank, more particularly on the major surface of the lens blank opposite to the surface to be processed. (The major surface of the lens blank to be processed is sometimes termed the RX surface and the major surface facing towards the lens block is sometimes termed the CX surface.) A number of different methods exist for forming or attaching a lens-block onto a lens blank. For example, the first end of a pre-formed lens block may be heated to its softening or melting point, the softened end of the pre-formed lens block may be then positioned against the lens blank and allowed to solidify thereby attaching the lens block to the lens blank. Alternatively the lens blank may be positioned next to a blocking material receiving cavity and softened or melted lens blocking composition may be then inserted into the receiving cavity and allowed to solidify thereby forming a lens block onto the lens blank. As discussed in detail below, to allow for particularly advantageous methods of deblocking, blocking is desirably achieved by applying a tape onto the lens blank over the major surface of the lens blank prior to forming or attaching the lens block, where then the lens block is formed or attached onto the applied tape. Again a number of different methods exist for forming or attaching a lens block onto the applied tape on a lens blank. For example, the first end of a pre-formed lens block may be heated to its softening or melting point, the softened end of the pre-formed lens block may be then positioned against the applied tape on the lens blank and allowed to solidify thereby attaching the lens block to the applied tape on the lens blank. Alternatively the lens blank with the applied tape may be positioned next to a blocking material receiving cavity, where the applied tape faces toward the cavity, and softened or melted lens blocking composition may be then inserted into the receiving cavity and allowed to solidify thereby forming a lens block onto the applied tape on the lens blank. Suitable tapes are commercially available, for example under the trade designation 3M Surface Saver (reference numbers 1640 and 1641) from 3M Company. After blocking, the exposed surface of the lens block may be processed as needed and/or desired in one or more lens processing operations. After processing, the processed lens is detached from the lens block.

In methods in accordance with the present invention the lens block is deblocked, by cutting the lens block through its diameter near the first end. For example, referring to FIG. 1, the lens block may be suitably cut through its diameter near its first end along the dashed line. It will be appreciated that the particular position of the cut (e.g. the distance from first end of the lens block) will depend on a number of factors, such as the particular method of cutting used, the curvature of the major surface of the processed lens facing towards the first end of the lens block, composition of lens (e.g. plastic or glass); desired and/or needed distance from the processed lens to prevent damage and/or minimize the risk of damage to the lens. While taking into consideration and balancing these various factors, desirably the lens block is cut through its diameter as close as possible to its first end, so that the amount of residual blocking composition remaining after cutting is as low as possible.

Cutting may be achieved by holding the lens-block assembly stationary and moving a cutter (e.g. a hot-wire cutter, a hot-blade cutter, an ultrasonic cutter, a laser beam or a water-jet) through the diameter of the lens block, or conversely by holding the cutter stationary and moving the lens-block assembly so that the lens-block passes through the cutter. Alternatively movement may be applied to both the cutter and lens-block assembly. For example, the lens-block assembly may be rotated as the cutter moves through the diameter of the lens block. Cutting may be achieved by a single cutter or two or more cutters.

If desired, e.g. to facilitate speed and/or ease in cutting of lens block depending on the particular cutting method used, the lens block or the lens-block assembly may be warmed (e.g. to a temperature of 30° C. or higher) prior to or during the operation of cutting of the lens block. This may be particularly advantageous for block compositions having a melting point or a softening point of 85° C. or less (more particularly 70° C. or less, most particularly 60° C. or less). If such warming is applied, desirably the lens block or the lens-block assembly is only warmed to a temperature where the lens block would start to soften or be soften, but would not melt. In particular, it may be desirable to warm the lens block or lens-block assembly to a temperature equal to the softening point temperature or lower (e.g. 1 to 5° C. lower) than the softening point temperature of the (residual) block composition prior to or during the operation of cutting of the lens block. Also it will be appreciated that if such warming is applied, desirably the lens of the lens-block assembly is not warmed up to a temperature where the lens would be damaged or distorted. Generally plastic lenses can be warmed to a temperature of about 45° C. or less, more suitably 40° C. or less, while glass lenses can be warmed to a temperature of about 80° C. or less, more suitably about 75° C. or less. Preferably a method of cutting is used that allows for quick and easy cutting without a warming of the lens block or lens-block assembly prior to or during cutting.

For assemblies where the lens block is formed or attached directly onto the lens blank/processed lens (not shown), after cutting, the residual amount of lens block composition remaining on the processed lens can be removed, e.g. mechanically or by melting or by cleaning with water or by cleaning with/immersion in an appropriate solution, depending on the particular lens block composition. Again depending on the particular lens block composition, since the residual amount of block composition remaining is small its removal may be achieved with relative ease. Depending on the particular cutting method used and the particular composition of the block, the residual amount of lens block composition may be at least in part softened or slightly melted facilitating ease in removal of the residue.

As mentioned above, it has been found particularly advantageous to use a tape between the lens block and lens blank so that after processing the lens and cutting the lens block the tape can be removed from the processed lens and thereby the residual amount of lens block composition remaining after cutting. This can be best understood by reference to FIG. 2 showing the respective portions of the assembly shown in FIG. 1 after cutting the lens block through its diameter along the dashed line in FIG. 1. In particular referring to FIG. 1, the illustrated assembly includes a tape (4) located between the first end (21) of the lens block (2) and the major surface of the processed lens (1) facing towards the lens, and referring to FIG. 2 cutting through the lens block results in two portions or subassemblies: one subassembly including the processed lens (1), tape (4) and a residual amount of blocking composition (23) and a second including a substantial part of the cut lens block (24) and the optional base block (3). As indicated by the small arrow in FIG. 2, the tape (4) can then be removed from (e.g. peeled off) the processed lens and therewith the residual amount of blocking composition (23) remaining on the tape after cutting the lens block. It will be appreciated that the operations of cutting the lens block and removing the tape can be performed as two separate steps or nearly concurrently where the tape is progressively removed for example during cutting and “just behind” the cutting through the lens block. Generally for inter alia reasons of practicality, the operations of cutting the lens block and removing the tape will typically be performed in two separate steps. Again depending on the particular cutting method used and the particular block composition, the residual amount of lens block composition remaining after cutting may be at least in part softened or slightly melted, allowing for ease of removal of the tape despite the presence of the residual block composition thereon. If desired, e.g. to ensure quick and easy removal of the tape and/or to minimize or prevent exertion of stress on the processed lens during removal of the tape with the residual block composition thereon, depending on the particular lens block composition, the lens-tape-subassembly resulting after cutting may be warmed (in particular to a temperature of 30° C. or higher) prior to or during the operation of removing the tape. This may be particularly advantageous for block compositions having a melting point or a softening point of 85° C. or less (more particularly 70° C. or less, most particularly 60° C. or less). The temperature up to which the lens-tape subassembly may be warmed depends on the particular lens composition and/or dimensions of lens as well as block composition. The lens-tape subassembly is desirably warmed to a temperature equal to or higher than the softening point temperature of the (residual) block composition. Generally a plastic lens-tape subassembly may be suitably warmed to a temperature of about 45° C. or less, more suitably 40° C. or less and a glass lens-tape subassembly may be suitably warmed to a temperature of about 80° C. or less, more suitably about 75° C. or less. Alternatively, if desired, again e.g. to ensure quick and easy removal of the tape, the lens-tape-subassembly resulting after cutting may be cooled to a temperature below the glass transition temperature(s) of the adhesive(s) of the tape, e.g. by quenching/immersing in liquid nitrogen or in cooled alcohol (e.g. methanol, ethanol, isopropyl alcohol cooled by dry ice). After removing the tape, the tape together with the residual amount of block composition will be typically disposed. However if there is a desire to recover the residual amount of block composition (e.g. for recycling, if residual block composition is recyclable), the removed tape can be further processed to remove (for example mechanically (e.g. by scraping) or thermally (e.g. by melting)) and to recover the residual amount of block composition.

Again referring to FIG. 2, in a block-base block subassembly obtained after cutting a lens block of the lens-block assembly including a base block, the substantial portion of the lens block (24) can be detached from the base block (3), for example by peeling or cutting the block off the base. In lens-block assemblies where a base block is not used, e.g. the lens block is configured with a rear portion that is sized and adapted to the chuck of the desired lens processing machine(s), after cutting the lens block as described herein a substantial portion of lens block is immediately recovered without any further operational step. Deblocking by cutting the lens block as described herein thus advantageously allows for a clean, effective and efficient deblocking of the lens block where a substantial portion of the lens block is recovered intact. Accordingly methods described herein are particularly advantageous for use with recyclable non-metal-alloy blocking compositions where the recovered lens block composition can be re-used, typically either re-softened or re-melted, to form new lens blocks. Recyclable non-metal-alloy blocking compositions include wax-based blocking compositions as well as thermoplastic blocking compositions.

Methods described herein are particularly advantageous for use with thermoplastic blocking compositions comprising a thermoplastic material selected from the group consisting of polyesters, polyurethanes, ionomer resins of ethylene copolymers, polyester-polysiloxane block copolymers, segmented copolyesters and polyetheresters, ethylene vinyl acetate resins and copolymers, polycaprolactones and blends of polycaprolactones, more particularly thermoplastic blocking compositions comprising a polycaprolactone or a blend of polycaprolactones.

Other aspects of the present invention include machines for carrying out methods described herein. One such machine is a machine for deblocking a non-metal-alloy lens block on a processed lens, said lens block having a first end facing towards the processed lens, the machine comprising at least one cutter and the machine being adapted and configured for cutting the lens block through its diameter near said first end. In preferred embodiments of such machines for deblocking lens-block assemblies where a tape is located between the first end of the lens block and the major surface of the processed lens facing towards the lens block, the machine is desirably further adapted and configured for removing the tape and thereby removing residual amount of lens block composition remaining after cutting. Another machine is a machine for processing a lens, the machine comprising a production line defined by a series of operating stations, the production line comprising a lens blocking station for forming or attaching a non-metal-alloy lens block onto the lens blank, such that a first end of the lens block faces towards a major surface of the lens blank, said major surface being opposite to the surface of the lens blank to be processed; one or more processing stations for processing the exposed surface of the lens blank; and a deblocking station comprising at least one cutter for cutting the lens block through its diameter near said first end. Such machines comprising a production line, desirably further comprise in the production line upstream to the lens blocking station a tape application station for applying a tape to the major surface of the lens blank, wherein the lens blocking station is adapted and configured for forming or attaching the lens block onto the tape applied to the major surface of the lens blank in the tape application station, and wherein either the production line or the deblocking station of the production line further comprises a tape removing station or sub-station, respectively, for removing the tape from the processed lens after cutting of the lens block.

Machines for deblocking and deblocking stations of machines for processing lenses may advantageously further comprise at least one sensor for sensing the position and/or the form of the processed lens, in particular for sensing the position and/or the form of the major surface of the processed lens facing towards the lens block. Such machines for deblocking and deblocking stations of machines for processing lenses may advantageously further comprise a control system for controlling the cutting of the lens block in consideration of sensed position and/or form of the processed lens, in particular in consideration of sensed position and/or form of the major surface of the processed lens facing towards the lens block. The controlling system may control the cutting in accordance to a pre-defined cutting operation for a particular position and/or form. In other words in consideration of sensed position and/or form, the controlling system may favorably select and allow for cutting in accordance to a particular cutting operation pre-defined for that particular position and/or form. Alternatively the controlling system may control the cutting dynamically (e.g. “on-the-fly”) in consideration of sensed position and/or form. Or favorably the controlling system may control cutting through a combination pre-defined and dynamic controlling. It will be appreciated by the skilled reader that processed lenses in lens-block assemblies will have varying thicknesses and the major surface (i.e. the major surface facing towards the lens block) of such lenses will have varying forms (e.g. varying curvatures, for example a CX surface can have a form of an arc of a circle having a radius between 50-300 mm). The use of deblocking machines or deblocking stations favorably including at least one sensor and a control system as described is advantageous in ensuring an optimum position of the cut through the lens block near its first end (e.g. an optimum distance from the first end of the lens block) for a particular processed lens/lens-block assembly, while at the same time minimizing any potential of damage to the processed lens during cutting as the result of uncontrolled cutting conditions.

In order to yet further minimize any potential damage to the processed lens during cutting, the at least one cutter of machines described here is desirably a fine or precision cutter and in methods described herein the lens block is desirably cut via a cutting method allowing for a fine and/or precision cut through the lens block. In particular, it is desirable that the lens block is cut via hot-cutting (in particular hot-wire or hot-blade cutting), ultrasonic cutting, laser cutting, or water jet cutting. These methods are also advantageous in that they generally facilitate rapid cutting and thus rapid deblocking, desirable for in-line processing facilities. Accordingly, in favorable embodiments of machines described herein, the at least one cutter is advantageously selected from the group consisting of a hot cutter (in particular a hot wire cutter or a hot blade cutter), a laser cutter, an ultrasonic cutter and a water jet cutter.

Hot-cutting, in particular cutting by hot-wire or hot-blade, is advantageous in that it is a cost-effective and efficient method of fine or precision cutting and in that the cutting is substantially achieved through energy other than mechanical force, i.e. thermal energy (thereby further minimizing a potential of damage to the processed lens by mechanical stress). Such cutting is also particularly suitable for cutting lens blocks made of a block composition having a melting point or a softening point of 85° C. or less (more particularly 70° C. or less, most particularly 60° C. or less). It has been found that lens blocks having a diameter of 40 mm and made of a composition comprising a polycaprolactone (in particular a blend of two polycaprolactones) and a melting point in the range of about 50° C. can be cut, and thus deblocked, in about 90 sec, using a hot wire cutter having a round wire diameter of 0.55 mm and a wire temperature of about 180° C. (power provided par Joule effect about 4 Watts) if prior to cutting the lens block is warmed to about 45° C., the cutting time is about 30 sec. Such lens blocks can be cut, and thus deblocked, in about 20 sec (without warming the lens block prior to cutting) using a hot wire cutter of same wire diameter and a wire temperature of about 400° C. (power provided par Joule effect about 25 Watts); and in about 15 sec with a wire temperature of about 500° C. (power provided par Joule effect 30 Watts). Also after cutting such lens block formed or attached onto an applied surface tape, the tape together with the residual amount of block composition (e.g. approximately 1 to 4 mm in thickness) can be simply peeled off the underlying lens. Surprisingly, it was observed that the use of hot cutting with a hot wire having high temperatures in close proximity to the processed lens did not lead to thermal damage to the processed lens. Without wishing to be bound to a particular theory, it is believed that due to the fact that for hot wire cutting (as well as hot blade cutting and laser cutting) the thermal energy is focused at the cutting edge and the dwell time is very short, the actual energy input is very low, and accordingly any potential for energy transfer is minimal (if not zero or approaching zero), so that the processed lens, being anyways additionally insulated by lens block material or, if applicable, tape and the lens block material between the lens and cutter, remains essentially unaffected and undamaged despite the close proximity of high temperatures. Also it was noted that the use of hot cutting with a hot wire having high temperatures did not lead to observable “damage” (e.g. charring) of deblocked polycaprolactone-comprising lens blocks (i.e. the substantial portion thereof recovered after cutting) and that the recovered, deblocked polycaprolactone-comprising lens blocks could be readily recycled (i.e. re-melted or re-softened to form new lens blocks). Again without wishing to be bound to a particular theory due to the fact that for hot wire cutting (as well as hot blade cutting and laser cutting) the actual energy input is very low and the potential of energy transfer is minimal, if not zero or near zero, it is believed that only the very immediate area of the lens block at the cutting line is affected (e.g. warmed) during cutting. Accordingly, hot cutting, in particular hot cutting by hot-wire or hot-blade, may be suitably performed at a temperature of up to about 500° C.

Hot blade cutting (also often termed hot knife cutting) has the advantages of hot wire cutting plus the additional advantage of higher physical stability of the cutter, which is desirable for prolonged and repeated use and for ease in controlling the cutter, e.g. controlling the position of the cutter relative to the lens of the lens-block. Preferably just the leading cut edge of the hot blade is heated. Furthermore hot blades can be readily formed into curved shapes, allowing the possibility of generally matching a hot blade cutter to the form of the major surface of the processed lens facing towards the lens block, for example an outwardly bowed (concave) hot blade for cutting a convex formed lens or a inwardly arched (convex) hot blade for cutting a concave formed lens. Along this line an in-line deblocking machine or deblocking station may be favorably provided with a selection of differently shaped hot blades and at least one sensor for sensing the form of the processed lens (e.g the form of the major surface facing towards the lens block), wherein in consideration of sensed form the machine selects (e.g. automatically moves in place) the appropriate shaped hot blade for the particular form.

As mentioned above other particularly desirable methods for use in cutting and thus deblocking in accordance to methods described herein include laser cutting, ultrasonic cutting and water jet cutting. Laser cutting has similar advantages as hot-wire cutting (such as low energy input and short dwell time, etc.) plus the additional advantages of potentially even higher throughput (e.g. quicker cutting and deblocking times), easy control as well as a high level of control of the laser beam (its size, shape, energy, etc.) and precision of cutting, as well as the advantage that the cutter, i.e. the laser beam, is not physical and thus does not require cleaning. In ultrasonic cutting, a cutter (e.g. a blade) is vibrated or excited at high frequency (generally at a frequency of 20 kHz or higher). Ultrasonic cutting is advantageous in besides allowing for precision cutting, ultrasonic blades cut without exerting pressure and ultrasonic blades are “self-cleaning” (e.g. cutting sludge is immediately removed due to the ultrasonic oscillations). Water-jet cutting including pure water-jet cutting and abrasive water-jet allows for quick, cold, precision cutting (streams diameters down to 0.1 mm are common) with extremely low or low cutting forces and with no or nearly no mechanical stress, and thus the use of water-jet cutting, in particular pure water jet cutting, is particularly favorable for use in cutting, and thus deblocking, lens blocks as described herein. Water jet cutting is also advantageous in that it is cost-effective, clean per se and does not require downtime to clean cutting tools. All these methods similar to hot cutting with a hot-wire or a hot blade allow for quick and easy cutting without warming the lens block or lens-block assembly prior to or during cutting.

Methods described herein are particularly suitable for use in deblocking, blocking and deblocking, and/or processing ophthalmic lenses. Machines described herein are particularly suitable for use in deblocking and/or processing ophthalmic lenses.

1-26. (canceled)

27. A method of deblocking a non-metal-alloy lens block on a processed lens, said lens block having a first end facing towards the processed lens, said method comprising cutting the lens block through its diameter near said first end.

28. The method of claim 27, wherein a tape is located between the first end of the lens block and the major surface of the processed lens facing towards the lens block and wherein said method further comprises removing the tape thereby removing residual amount of lens block composition remaining after cutting.

29. The method of claim 28, further comprising applying a tape over the major surface of the lens blank prior to forming or attaching the lens block and removing the tape subsequent to cutting the lens block, and wherein in the step of forming or attaching the lens block, the lens block is formed or attached onto the applied tape.

30. The method of claim 28, wherein after cutting a lens-tape sub-assembly results and said lens-tape subassembly is warmed prior to or during the operation of removing the tape.

31. The method of claim 28, wherein after cutting a lens-tape sub-assembly results and said lens-tape subassembly is cooled to a temperature below the glass transition temperature(s) of the adhesive(s) of the tape prior to removing the tape.

32. The method of claim 27, wherein the lens block or lens-block assembly is warmed prior to or during the operation of cutting the lens block.

33. The method of claim 27, wherein the lens block is made of a composition having a melting point or softening point of 85° C. or less, in particular 70° C. or less and more particularly 60° C. or less.

34. A method of processing a lens, said method comprising:
providing a lens blank;
forming or attaching a non-metal-alloy lens block onto the lens blank, such that a first end of the lens block faces towards a major surface of the lens blank, said major surface of the lens blank being opposite to the surface of the lens blank to be processed; and
cutting the lens block through its diameter near said first end.

35. A machine for deblocking a non-metal-alloy lens block on a processed lens, said lens block having a first end facing towards the processed lens, the machine comprising at least one cutter and the machine being adapted and configured for cutting the lens block through its diameter near said first end.

36. The machine of claim 35, wherein a tape is located between the first end of the lens block and the major surface of the processed lens facing towards the lens block, wherein the machine is further adapted and configured for removing the tape thereby removing residual amount of lens block composition remaining after cutting.

37. A machine for processing a lens, the machine comprising a production line defined by a series of operating stations, the production line comprising a lens blocking station for forming or attaching a non-metal-alloy lens block onto the lens blank, such that a first end of the lens block faces towards a major surface of the lens blank, said major surface being opposite to the surface of the lens blank to be processed; one or more processing stations for processing the exposed surface of the lens blank; and a deblocking station comprising at least one cutter for cutting the lens block through its diameter near said first end.

38. The machine of claim 37, wherein the production line further comprises upstream to the lens blocking station a tape application station for applying a tape to the major surface of the lens blank, wherein either production line or the deblocking station further comprises a tape removing station or sub-station, respectively, for removing the tape from the processed lens after cutting of the lens block, and wherein the lens blocking station is adapted and configured for forming or attaching the lens block onto the tape applied to the major surface of the lens blank in the tape application station.
